(19) United States
(12) Patent Application Publication
(10) Pub. No.: US 2011/0129174 A1
(43) Pub. Date: Jun. 2, 2011

(54) SLEEVE BEARING SYSTEM

(75) Inventors: YUNG-PING LIN, Tu-Cheng (TW); DUNG-CHANG YEH, Tu-Cheng (TW); CHIEN-LONG HONG, Tu-Cheng (TW); DENG-CHU FU, Shenzhen City (CN); QIANG ZHANG, Shenzhen City (CN)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/727,249

(22) Filed: Mar. 19, 2010

(30) Foreign Application Priority Data
Nov. 30, 2009 (CN) 200910310701.4

(51) Int. Cl. F16C 33/02

(52) U.S. Cl. 384/276

(57) ABSTRACT

A sleeve bearing system includes a bearing housing, a sleeve bearing received in the bearing housing, and a wear-resistant pad received at a bottom of the bearing housing. The bearing housing defines a receiving recess therein for receiving the sleeve bearing. The wear-resistant pad is sandwiched between the sleeve bearing and a bottom of the bearing housing. The wear-resistant pad includes a central supporting portion aligning with the bearing hole of the sleeve bearing and a plurality of ears extending radially and outwardly from and an outer periphery of the supporting portion. A reservoir is defined between adjacent ears around the supporting portion.

### BACKGROUND

1. Technical Field

The disclosure generally relates to bearing systems, and particularly to a sleeve bearing system for motors.

2. Description of Related Art

Sleeve bearings are widely used in a plurality of bearing systems for motors, such as fan motors and disk drive motors in computers. Sleeve bearings reduce abrasion of shafts in the motors, and decrease noise from the motors.

The material of the sleeve bearing is usually porous for absorbing lubricant which lubricates the shaft during rotation of the shaft. However, the lubricant absorbed in the sleeve bearing evaporates and creeps out from the sleeve bearing easily when the shaft rotates at a high speed. Thus, the lubrication is reduced faster than desired, and the friction between the sleeve bearing and the shaft is increased, thereby reducing the efficiency of the sleeve bearing system and generating noise.

Therefore, what is needed is a sleeve bearing system that can overcome the above-described limitations.

### BRIEF DESCRIPTION OF THE DRAWINGS

FIG. 1 is an isometric, assembled view of a sleeve bearing system in accordance with an embodiment of the present disclosure.

FIG. 2 is an exploded view of the sleeve bearing system of FIG. 1.

FIG. 3 is a cross-section of the sleeve bearing system of FIG. 1.

FIG. 4 is a top plan view of a wear-resistant pad of a sleeve bearing system in accordance with an alternative embodiment of the present disclosure.

### DETAILED DESCRIPTION

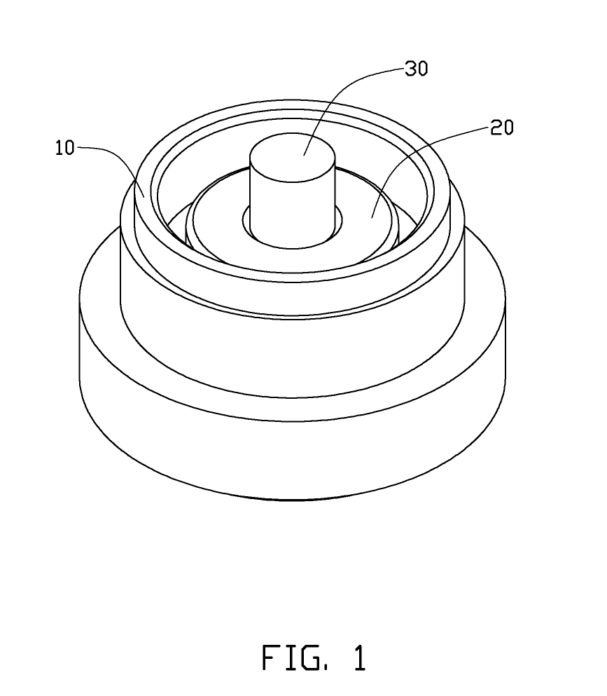

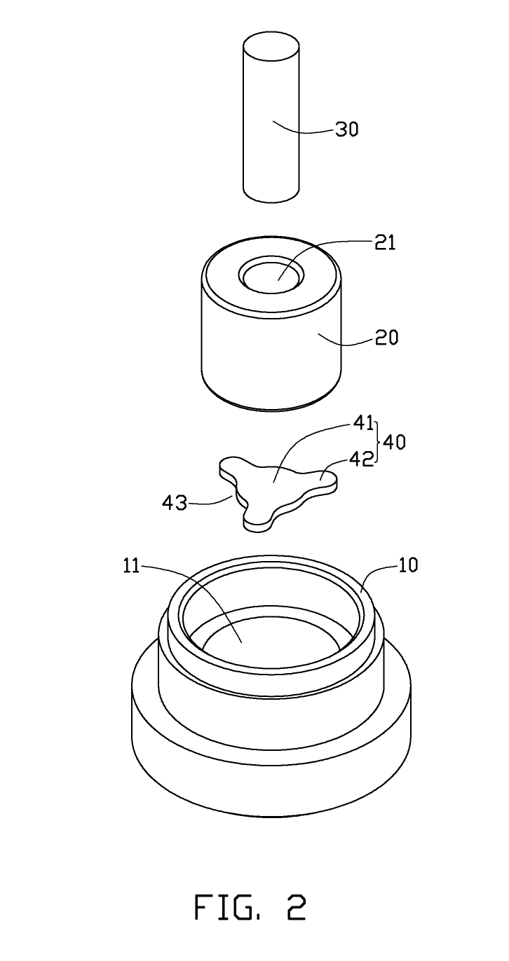

Referring to FIGS. 1-3, a sleeve bearing system according to an embodiment of the present disclosure is shown. The sleeve bearing system includes a bearing housing 10, a sleeve bearing 20 received in the bearing housing 10, a shaft 30 rotatably inserted in the sleeve bearing 20, and a wear-resistant pad 40 received in the bearing housing 10 and disposed at a bottom of the sleeve bearing 20.

The bearing housing 10 has a general U-shaped cross section with a bottom end closed. A receiving recess 11 is defined in the bearing housing 10, and a bottom plate 12 is formed at the bottom end of the bearing housing 10 to seal the bottom end of the bearing housing 10.

The sleeve bearing 20 is substantially cylindrical, with a bearing hole 21 defined along an axial direction thereof. The bearing hole 21 is configured for rotatably receiving the shaft 30. The sleeve bearing 20 is made of porous metal and saturated with lubrication to lubricate the shaft 30 during rotation of the shaft 30.

The wear-resistant pad 40 is positioned between the bottom plate 12 of the bearing housing 10 and a bottom end of the sleeve bearing 20 for axially supporting the shaft 30. The wear-resistant pad 40 is made of an abrasion resistant material and provided with high lubricity, to reduce friction between the wear-resistant pad 40 and the shaft 30. The wear-resistant pad 40 is substantially triangular, and includes a central supporting portion 41 and three ears 42 extending outwardly and radially from an outer periphery of the supporting portion 41. The supporting portion 41 is substantially circular, a diameter of which is slightly greater than that of the bearing hole 21 of the sleeve bearing 20. The ears 42 are evenly arranged around the supporting portion 41. An lubrication reservoir 43 is defined between the adjacent ears 42 at the outer periphery of the supporting portion 41, in cooperating with the bearing housing 10. There are in total three reservoirs 43 provided at the outer periphery of the supporting portion 41 between the ears 42. The reservoirs 43 are homocentric and evenly arranged around the supporting portion 41.

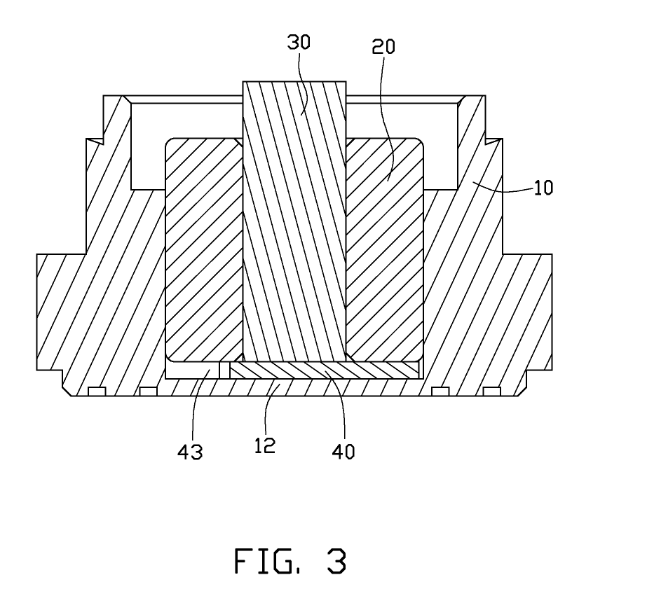

Referring to FIG. 3, during assembly of the sleeve bearing system, the wear-resistant pad 40 and the sleeve bearing 20 are disposed systematically in order in the receiving recess 11 of the bearing housing 10. The sleeve bearing 20 is pressed downwardly until the bottom end of the sleeve bearing 20 abuts on the wear-resistant pad 40. Thereafter, the shaft 30 is inserted into the bearing hole 21 of the sleeve bearing 20. The wear-resistant pad 40 is sandwiched between the sleeve bearing 20 and the bottom plate 12 of the bearing housing 10. The supporting portion 41 of the wearing-resistant pad 40 aligns with the bearing hole 21 of the sleeve bearing 20, and the bottom end of the shaft 30 abuts on the supporting portion 41 of the wear-resistant pad 40. Free ends of the ears 42 abut against an inner surface of the bearing housing 10.

In the present disclosure, lubricant creeping out from the bottom of the sleeve bearing 20 is reserved in the reservoirs 43 of the wearing-resistant pad 40, a capillary force of the bottom of the sleeve bearing 20 accordingly excesses that of a top of the sleeve bearing 20, whereby the lubricant absorbed in the top of the sleeve bearing 20 is easily transferred to the bottom of the sleeve bearing 20 due to the capillary force of the bottom of the sleeve bearing 20, thus keeping a uniform distribution of the lubricant in the sleeve bearing 20 and reducing a leakage and evaporation of the lubricant from the top of the sleeve bearing 20. Furthermore, the lubricant reserved in the reservoirs 43 of the wear-resistant pad 40 can be absorbed by the sleeve bearing 20 again when a quantity of the lubricant in the sleeve bearing 20 is reduced, thus drying up of the lubricant is avoided in the sleeve bearing 20.

Understandably, to ensure an adequate quantity of lubricant reserved in the bearing system, appropriate amount of lubricant can be injected in the receiving recess 11 of the bearing housing 10 when the wear-resistant pad 40 is disposed in the receiving recess 11 of the bearing housing 10. The injected lubricant is reserved in the reservoirs 43 of the wear-resistant pad 40 for standby.

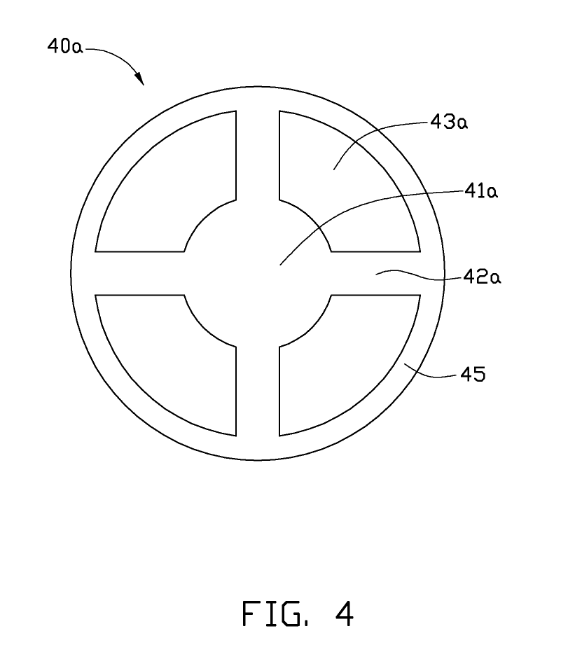

Referring to FIG. 4, a wear-resistant pad 40a according to an alternative embodiment of the present disclosure is shown. The wear-resistant pad 40a includes a central supporting portion 41a, four ears 42a extending radially outwardly from an outer periphery of the supporting portion 41a, and an outer ring 45 connecting free ends of the ears 42a together. The ears 42a are evenly arranged around the supporting portion 41a. A reservoir 43a is defined between the adjacent ears 42a at the outer periphery of the supporting portion 41a. The ring 45 is circular and spaced from the supporting portion 41a of the wear-resistant pad 40a. The reservoirs 43a are defined between the supporting portion 41a and the ring 45 and evenly arranged around the supporting portion 41a. The reservoirs 43a are sector-shaped and homocentric. The ring 45 connects the free ends of the ears 42a together, thus enforcing the stability of the wear-resistant pad 40a.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sleeve bearing system, comprising:
a bearing housing defining a receiving recess therein;
a sleeve bearing received in the receiving recess of the bearing housing, the sleeve bearing defining a bearing hole therein for rotatably receiving a shaft; and
a wear-resistant pad received in the receiving recess of the bearing housing and sandwiched between the sleeve bearing and a bottom of the bearing housing, the wear-resistant pad comprising a central supporting portion and a plurality of ears extending outwardly and radially from an outer periphery of the supporting portion, the supporting portion aligning with the bearing hole of the sleeve bearing, an reservoir being defined between adjacent ears around the supporting portion.

2. The sleeve bearing system of claim 1, wherein the ears are evenly arranged around the supporting portion of the wear-resistant pad.

3. The sleeve bearing system of claim 2, wherein the wear-resistant pad further comprises an outer ring spaced from the supporting portion of the wear-resistant pad, the ring connects free ends of the ears together, and the reservoir is defined between the supporting portion and the outer ring, in cooperation with the bearing housing.

4. The sleeve bearing system of claim 3, wherein the ears comprise four ears, and four reservoirs are defined in the wear-resistant pad, the four oil reservoirs are evenly arranged around the supporting portion.

5. The sleeve bearing system of claim 3, wherein the reservoirs are sector-shaped and homocentric, and evenly arranged around the supporting portion.

6. The sleeve bearing system of claim 1, wherein the sleeve bearing is made of porous metal.

7. The sleeve bearing system of claim 1, wherein the supporting portion is circular, and a diameter of the supporting portion is slightly greater than that of the bearing hole of the sleeve bearing.

8. The sleeve bearing system of claim 1, wherein the wear-resistant pad is of an abrasion resistant material and provided with high lubricity.

9. The sleeve bearing system of claim 1, wherein the supporting portion is circular, and there are three ears extending from the supporting portion.

10. The sleeve bearing system of claim 1, wherein free ends of the ears abut against an inner surface of the bearing housing.
